(19) United States
(12) Patent Application Publication
(10) Pub. No.: US 2006/0121908 A1
(43) Pub. Date: Jun. 8, 2006

(54) Predictive service connection transfer for mobile telephones

(76) Inventor: Dan Kikinis, Saratoga, CA (US)

Correspondence Address: CENTRAL COAST PATENT AGENCY, PO BOX 187, AROMAS, CA, 95004, US

(21) Appl. No.: 11/293,415

(22) Filed: Dec. 2, 2005

Related U.S. Application Data
(60) Provisional application No. 60/634,630, filed on Dec. 8, 2004.

(51) Int. Cl. H04Q 7/20

(52) U.S. Cl. 455/447

(57) ABSTRACT

A system for predicting a channel reassignment for a mobile communications device engaged in a call while traversing from one to another cell of a wireless communications region includes a first node and software routine for qualifying the mobile communications device and for tracking the mobile communications device; a second software routine running on the first node for predicting a time of need for the channel reassignment to the mobile communications device; a third software routine running on the first node for predicting bandwidth availability to the mobile communications device at the time of need; and a fourth software routine running on the first node for causing execution of the channel reassignment at the predicted time of need of the channel reassignment and for causing notification to the mobile communications device in the event of insufficient bandwidth at a point before the predicted time of need for the channel reassignment.

### CROSS-REFERENCE TO RELATED APPLICATIONS

The present application claims priority to Provisional application 60/634,630, filed on Dec. 08, 2004, which is incorporated herein in its entirety by reference.

### BACKGROUND OF THE INVENTION

1. Field of the Invention

The present invention is in the field of mobile computing including wireless communication and pertains particularly to methods for predicting the need for and executing a frequency change for mobile telephone users whom are in transit and engaged in communication.

2. Discussion of the State of the Art

In the field of mobile computing, more particularly wireless mobile telephony, or even more specifically, cellular telephony, it is common for an active call to suddenly drop off for a user when he or she is engaged in a call while driving through several cells in a carrier network. There may be several causes for a cell call to be dropped while in progress. One common reason is that a user moves through an area toward the carrier's service boundary culminating in a weak cell signal such that there is not enough of a signal to maintain the connection. Another common problem may be that a user exiting one cell area and entering another cell area may have his or her call dropped because there are no available frequencies in the subsequent cell area to transfer the call to. Transferring a connection from one signal source or tower to another is called a cell frequency handoff or transfer.

A telephone carrier's geographic coverage area is typically divided into a plurality of small cells averaging about up to 10 square miles. Each cell has a tower and a base station for setting up calls and maintaining connectivity for those calls as they move through subsequent cells of the coverage area. Typically the calling party is assigned a frequency and the called party is assigned a different frequency during a session. This enables full duplex communication. Optimally, a cellular call in progress may be maintained when crossing cellular tower signal boundaries (cells) while a call is in progress. A mobile Telephone Switching Office (MSTO) typically negotiates cell transfers when a mobile telephone is traversing multiple cells. However, there is no guarantee that a successful transfer to a new frequency will occur each time. Other, novel technologies have different modes of operation, but generally operate in similar manner, including but not limited to wireless fidelity (WiFi), Worldwide Interoperability for Microwave Access (WiMax), universal mobile telecommunications system (UMTS), wide band code division multiple access (W-CDMA) etc.

In some cases, such as when there are numerous users actively engaged in conversation in a given cell, there may not be enough bandwidth to maintain active calls entering a particular cell. Rush hours, special events, emergency evacuations, and other high peak use cases may contribute to this problem. Calls may be dropped without the user receiving any kind of alert or notification that the call is going to be dropped. This is a source of inconvenience and frustration for many users. Likewise, where different carrier networks overlap, service may be interrupted by an inadvertent change to a different carrier's service that may not support the communication session in progress.

What is clearly needed is a method and apparatus for predicting when a cell phone user may need a new frequency assignment for an active call or connection and reserving the bandwidth in the subsequent cell or coverage area for that user thereby preventing or reducing incidents of dropped calls in the cell boundary regions.

### SUMMARY OF THE INVENTION

According to some cases of the present invention, a system for predicting a requirement for a channel reassignment for a mobile communications device engaged in a call while traversing from one to another cell of a wireless communications region is provided. This does not have to be limited to a radio frequency channel, but could also be any type or combination of logical or time division etc. The system includes a first node running a first software routine for qualifying the mobile communications device for tracking and for tracking the mobile communications device on a trajectory; a second software routine running on the first node or another node connected thereto for predicting a time of need for the channel reassignment to the mobile communications device; a third software routine running on the first node or on another node connected thereto for predicting bandwidth availability to the mobile communications device at the time of need, the prediction made at a point before the predicted time of need of the channel reassignment; and a fourth software routine running on the first node or another node connected thereto for causing execution of the channel reassignment substantially near the predicted time of need of the channel reassignment and for causing notification to the mobile communications device in the event of insufficient bandwidth at a point before the predicted time of need for the channel reassignment.

In some cases, the mobile communication device is one of a cellular telephone, a laptop, or a personal digital assistant. In some cases, the wireless communication is analog. In some cases, the wireless communication is digital. In some cases, the first node is a server node maintained by a wireless carrier responsible for the wireless communications region. In another case, the first node is a router.

In a preferred case, qualification includes determination that the device is in transit in a manner that creates a trajectory. In one case, the trajectory is mapped to one of a thoroughfare, a highway, a street, or a transit route. Also in one case, tracking is achieved using a global positioning satellite. In another case, tracking is achieved using triangulation. In yet other cases, other suitable technologies may be used, similar of what is used in E911 location services etc.

In one case, the prediction of time of need is based on trajectory of the mobile communications device and the average speed of the device. In this case, the predicted time is substantially near the actual time the mobile communications device transverses the cell border.

In one case, the notification of insufficient bandwidth is one of a text message, an audible beep, a flashing icon, or a synthesized voice message breaking into the conversation. In one case, the system further includes a client application distributed to the mobile communications device, the client application adapted to initiate tracking, mapping and service negotiations performed by the system software routines.

According to another aspect of the present invention, a software application is provided for predicting and then routing channel reassignments to mobile communications devices engaged in communication sessions while traversing a cell border within a cellular service area. The application includes a first portion thereof for detecting trackable devices and for tracking qualified devices while in transit along a trajectory; a second portion thereof for mapping the trajectories to known routes and for predicting times at which those devices will need channel reassignments; and a third portion thereof for predicting bandwidth availability for the predicted channel reassignments and for reserving bandwidth for those reassignments.

In one case, the mobile communications devices are one or a mix of cellular telephones, laptop computers, or personal digital assistants. In another case, the application further includes a distributed client downloadable to the mobile communications devices and configurable to initiate service.

In still another case, the application further includes a portion thereof for executing channel reassignments and for causing notification to mobile communications devices in the event no bandwidth could be reserved. In this case, notification is one of a text message, a flashing icon, an audible beep, or a synthesized voice message inserted into the communication session.

In yet another aspect of the present invention, a method is provided for predicting a time of need for a channel reassignment for a mobile communications device traversing a border between cells in a wireless communications service area. The method includes acts for (a) detecting a mobile communications device in session; (b) determining the device is in transit on a trajectory; and (c) predicting when the device on the trajectory will cross a cell border into an adjacent cell. In one aspect, in act (a), the mobile communications device is one of a cell phone, a laptop computer, or a personal digital assistant. In one aspect, in act (b), the determination is based on at least 2 location requests based on one of global satellite positioning or triangulation. In a preferred aspect, in act (c), the prediction is performed via algorithm considering as variables direction of trajectory; average speed of the mobile communications device along the trajectory; and proximity of the mobile communications device on the trajectory in relation to the cell border at the time of prediction.

### BRIEF DESCRIPTION OF THE DRAWING FIGURES

FIG. 1 is an architectural overview of a wireless communications service area practicing predictive cell transfer according to embodiments of the present invention.

FIG. 2 is a process flow chart illustrating steps for predicting when frequency changes will be required and reserving those frequencies according to an embodiment of the present invention.

FIG. 3 is a block diagram illustrating basic components of the software of FIG. 1 according to an embodiment of the present invention.

### DETAILED DESCRIPTION

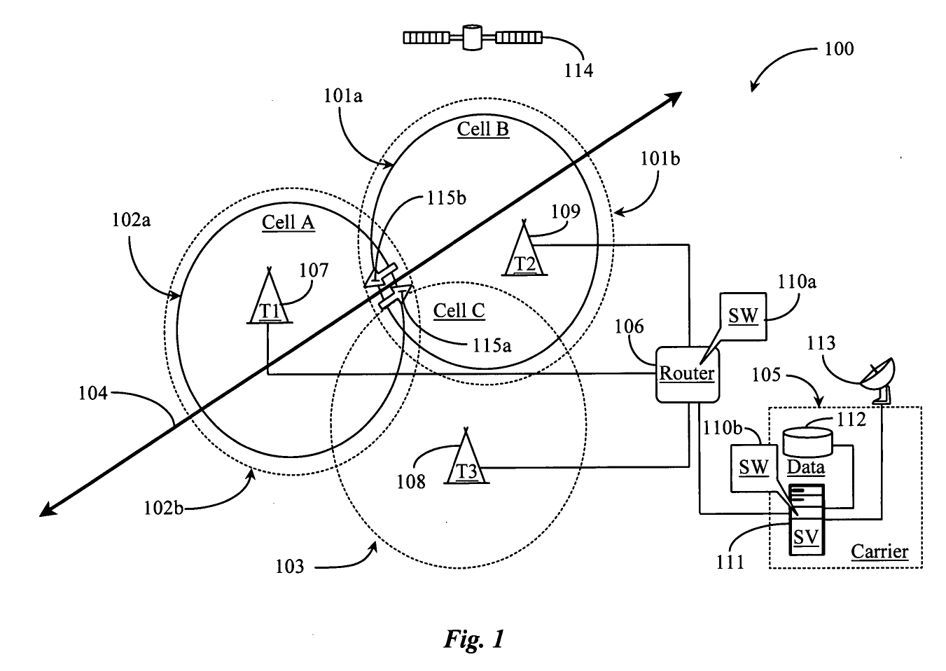

FIG. 1 is an architectural overview of a wireless communications service area 100 practicing predictive cell frequency transfers according to an embodiment of the present invention. Service area 100 represents for example a typical cellular telephone coverage area using analog or digital technology. It is clear, that it would similarly apply, if other wireless technologies were to be used, such as including but not limited to UMTS, W-CDMA, WiFi, and WiMax etc. It is noted herein that in analog technology, available frequencies for an entire coverage area are significantly less than those available in a 2^{nd} or 3^{rd} generation digital network. For example, a typical cell has 56 available channels while a digital cell may have up to 3 times as many available channels. Each channel involves 2 frequencies for full duplex communication or a duplex channel.

In this example, there are 3 illustrated cells, a cell A (102b), a cell B (101b), and a cell C (103). In this example the broken boundaries indicate the furthest reaches of each cell. Each cell A-C has a cell tower. These are illustrated in this example as a cell tower 107 in cell A, a cell tower 109 in cell B, and a cell tower 108 in cell C. Each cell tower is associated with local base station equipment not illustrated but assumed present in this example. Towers 107-109 provide communication connectivity within each cell and when mobile users are transitioning between cells. It will be apparent to one with skill in the art that there may be more individual cells making up a coverage area than are illustrated in this example without departing from the spirit and scope of the present invention. The inventor illustrates 3 cells and deems the number illustrated sufficient for the purposes of explaining the present invention. Also, in some cases, channels may not be limited to different radio frequency slots, but may also include by themselves or in combination Time Division Multiple Access (TDMA or TDM), Channel Division Multiple Access (CDMA), Digital Spread Spectrum (DSS) etc., which use logical channels rather than just radio frequency slots. Other similar technologies may also be employed by themselves or in conjunction.

Cell A and Cell B are illustrated as having inner boundaries denoting the outer boundary of each cell where the channel signal is still sufficiently strong. These are illustrated herein as a cell boundary 102a for cell A and a cell boundary 101a for cell B. Boundaries 102a and 101a are illustrated to aid in explanation of the present invention and the purpose of these boundaries will be described in detail further below and later in this specification.

A highway or thoroughfare 104 is illustrated in this example extending through coverage area 100. Highway 104 may be just one of many thoroughfares comprising roads or other traversable tracks that may extend through more than one cell or through all cells in a given service area. Two arrows 115a and 115b are illustrated in this example and are associated with thoroughfare 104. Arrows 115a and 115b represent mobile telephones operated by users traversing thoroughfare 104 from one cell to a next cell, the users traveling in opposite direction from one another on thoroughfare 104.

In this example, each cell tower 107-109 has connection to a router 106 responsible for routing calls within and to and from service area 100. Router 106 is typically maintained and operated by a service provider or carrier 105. Carrier 105 maintains active monitoring and control over activity in service area 100. In this example, carrier 105 is enhanced with an ability geographically track mobile telephones that are in use anywhere within service area 100. This requires that the telephones have tracking modes, which are set to tracking enabled. The service capability of tracking such phones is typically provided for emergency purposes so that if there is a distress call for example, the mobile phone source of the call may be geographically pinpointed anywhere in service area 100. Global Positioning Satellite (GPS) methods may be used to accomplish phone location and tracking. GPS tracking is illustrated in this case by a satellite 114 and a satellite transceiver 113. In this way, service carrier 105 may determine with some accuracy, the whereabouts of any user within the area that has his or her phone enabled for tracking.

Carrier 105 includes a data server (SV) 111 having a data repository 112 connected thereto. Server 111 within carrier domain 105 has a direct line connection to router 106 and to satellite system transceiver 113. SV 111 may receive data from transceiver 1 13 and may send data through transceiver 1 13. SV 111 may also send and receive data from router 106. The routing system used in service area 100 is dependant on towers 107-109 and router 106.

User 115a is illustrated in this example as leaving cell A and entering cell B. User 115b is illustrated as leaving cell B and entering cell A. It may be assumed in this example that users A and B both are using cell phones in conversation and that tracking for both telephones is turned on. Adjacent cells cannot share cell channels. Cell channels assigned to one cell may be re-used only in a non-adjacent cell.

An instance of software (SW) 110a is provided, in one case, to router 106 and is installed thereon and executable therefrom. SW 110a has the capability according to some cases of the present invention, of predicting when a channel reassignment or “tower handoff” might be required for any mobile and trackable cell user engaged in a conversation that is about to leave one cell and enter an adjacent cell. A software instance (SW) 110b is provided to SV 111 within the domain of carrier 105. SW 110b is adapted to communicate with SW 110a and cooperates with SW 110a in some cases. SW 110b is capable of determining available bandwidth in the cell being entered by a user and reserving bandwidth for the mobile phone about to enter the cell so that the existing connection has a better chance of being maintained in transit and not being dropped without warning.

In some cases, there are 2 separate instances of SW that cooperate, SW 110a installed on router 106 and SW instance 110b installed at SV 111. However, this is not specifically required in order to practice the present invention. In one example, the entire software capability may reside in router 106 or in server 111 without departing from the spirit and scope of the present invention. In yet other cases, one or more separate, dedicated computer(s) may be added in the pertinent locations to offer same performance as installing SW on existing equipment.

Considering user 115a, it is apparent in this example that the user is leaving cell A and is about to enter cell B while engaged in a conversation and driving on thoroughfare 104. In this case, the frequencies comprising the duplex channel used in cell A will shortly be unavailable as the user approaches the furthest boundary 102b of cell A. If cell B is saturated with activity, there may not be an assignable channel available to the user 115a and his call may be inadvertently disconnected or dropped without warning.

In one example of the present invention, the space between cell boundary 102a and cell boundary 102b is known to the software of the invention such that when user 115a enters this space a predictive calculation is performed to determine when the user will need a new channel. This calculation considers as variables the user's location information repeatedly reported to determine a reasonable trajectory and speed of travel against time intervals. The result is a window within which a pre-negotiation may occur on behalf of the user to ascertain availability of a channel at the predicted need time and, perhaps a reservation of a channel for the user assignable at the time of need. The same capability exists for user 115b traveling in the opposite direction leaving cell B and entering cell A.

In one example, GPS positioning and tracking is used in conjunction with a reliable geographic mapping service. Map data may be available from database 112 within carrier domain 105, or from an external data mapping service not illustrated in this example. In this case, the service of the present invention may be applied for trackable users who may be traveling known trajectories such as major highways and roads that extend through the cells. This case may consider that a user simply moving in a direction toward another cell may not actually enter that cell is the road he or she is using stays within the existing cell. In this way streamlining in determination of applicable users may occur such that every cell phone user engaged in conversation and close to a boundary is not tracked for service.

In some cases, rather than using maps, the system could simply graph the movement of users, thereby being able to predict that a user entering a certain area on a certain path (i.e. by freeway 101) will with a predictable chance leave the area on the same (or another route) again, therefore better preplanning the transfer. Also, a major intersection would show up, allowing predicting a change of route and therefore predicting a new exit route correctly. In yet another case, it could also learn the route of specific users, and rely on them to make even better prediction. That approach has also certain advantages to other modes of transport, such as walking, trains, bicycles etc. In yet other cases, a simulation may be used to predict the flow.

In one example of the present invention GPS is not used but some other method like triangulation between 3 geographic markers might be used. However, GPS is already available on most 2^{nd} and 3^{rd} generation handsets and requires only that “tracking” be turned on. Integration of a mapping feature simply enables a limit to the number of users that may be considered for service according to the present invention at any given time. In yet other cases, other suitable technologies similar to E911 may be used etc. Such technologies are known in the art and are not described in detail here.

Part of determining whether there are available channels in a next cell may be enhanced by the ability to predict a future time point for consideration. For example, if a user has 3 minutes before he or she will cross boundaries, then a window of opportunity is established. A cell with no channels available at the start time of that 3-minute window of time may have one or more users predicted to exit that cell within the window. In this case a tentative reservation may be made on behalf of the entering user for a channel predicted to be available by the end time of the window.

In one case, users in transit are not monitored by the system of the present invention, for predictive bandwidth reservation at least, unless they are within the inner and outer boundaries of a cell and are in fact moving out of that cell. However, all users within a cell and who are engaged in active conversation are considered in determination of available channels for assignment. In a preferred example of the present invention, if during a predictive time window a negotiation or determination and reservation of a channel cannot be assured for any user, then a “loss of connection” alert may be sent to the parties in question ahead of the drop of that connection giving the parties to the call time to finish there conversation or to schedule a resumption of their conversation if they cannot finish it in time.

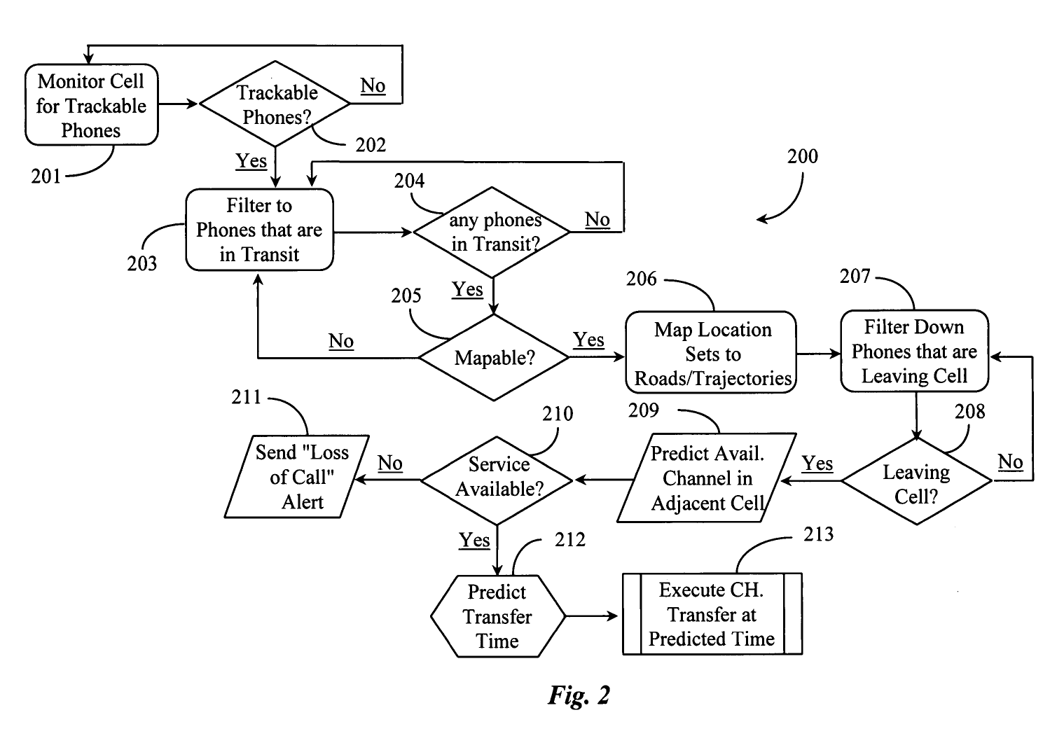

FIG. 2 is a process flow chart 200 illustrating acts for predicting when frequency changes will be required and reserving those frequencies according to an embodiment of the present invention. At act 201, any given cell in an area is monitored for trackable phones as an ongoing process. A trackable phone for the purposes of the present invention may be one that is turned on, engaged in an active connection, is set for tracking, is moving in some predicable trajectory, and perhaps is moving within a determined boundary space on that trajectory toward an adjacent cell with some measure of certainty that the user will continue into that adjacent cell.

At act 202, it is determined if there are-any trackable phones in the cell that fit the criteria. One with skill in the art will recognize that an initial check may consider, without elimination, all phones in a cell that are simply turned on, engaged on a channel, and have tracking turned on. Further monitoring is required to narrow the field to phones that fully fit the criteria for service according to the present invention as will be described in subsequent acts in this example.

At act 202 if the software does not recognize any trackable phones, then the process reverts back to act 201 and continues to monitor until one or more phones are recognized. At act 202, if there are one or more trackable phones within the cell, then the process continues to act 203, which applies a filter to determine the number of those phones that are in transit. Act 202 requires at least two location checks for each phone recognized in act 202 to determine if there has been a significant change in position. A threshold may be established that may help to refine the filtering out of those phones considered stationary. However, in one case where there is traffic congestion on a particular thoroughfare phones in transit may appear stationary. Therefore, other considerations like current traffic conditions may be considered in the determination for each user considered.

At act 204, if it is determined that there are no phones in transit, the process reverts back to act 203. This loop may continue while the process ensues. In fact each act in this process may be an ongoing process to ensure that all serviceable phones are detected and monitored. If at act 204, it is determined that there are one or more trackable phones in transit, then at step 205 a determination is made whether those identified phones in transit are mapable. It is noted herein that a phone in transit may include any trackable phone that is moving along a path. This may include phones used in cars, in taxis, in transit systems, from bicycles, and so on. A mapable state simply indicates that a phone in question can be pinpointed to a discernable trajectory such as on a thoroughfare, road, rail, or other locatable pathway having a known trajectory.

If at step 205, there are no mapable phones then the process reverts back to act 203. It may be that there are several phones in transit, but that none are progressing on a predictable trajectory. Talking on the phone and driving around the block would be a good example of this. The phone is in transit, but does not have a predictable trajectory. That phone may be eliminated or filtered out of the group of phones monitored.

If at act 205, one or more phones in transit are mapable according to set criteria, then at act 206 the software plots 2 or more location sets from each monitored phone to known roads or trajectories to establish a geographic time reference. Those phones that are determined to be traveling on a trajectory can be gauged for average speed by running a location/time algorithm along the trajectory. For example, on an unobstructed highway with little traffic, accurate speed may be reasonably calculated with little effort. On a congested road with frequent stops and starts, then more samples must be taken of each phone to predict an average speed along a given trajectory.

It is noted herein as well that any time during the monitoring process calls may be initiated and terminated at will by users so that new phones become trackable and phones being tracked disappear from the radar. The phones that disappear because a call was ended may reappear on the same trajectory, for example, at initiation or receipt of a next call. In this case, a margin of time may be allowed by the system for such phones whereby a predictive track using the last known data may still be propagated for that phone for a set period of time. In this way the phone in question, should it reappear within the set time frame can be prevented from elimination.

Once one or more phones are mapped and have reasonable trajectories, at act 207, the software may begin filtering the number down to those that are leaving the cell. In this case, it may be that only those phones entering a set boundary space before the outer boundary of the cell would be treated. This consideration might be important because one or more of the phones further within the cell may change course on a new trajectory that prevents them from leaving the cell at the predicted trajectory. Restricting consideration to those that are predicted to leave the cell with a reasonable certainty further streamlines the process. By providing a limited “buffer zone”, the system can be more certain that individual ones of the monitored phones will actually leave the cell while engaged in a conversation. If at act 208, no phones are leaving the cell, then the process reverts back to act 207.

Also, in some cases, operators may chose to selectively scan user's devices not on calls that approach a boundary at higher occurrence rate than normal (typically About 1 scan per minute) thus obtaining better resolution. This rate may also change with the speed of motion of the previous trajectory or other useful parameters.

It is important to note herein that the process of this example is practiced simultaneously with regard to all of the possible exit routes or trajectories from a cell that may qualify for consideration. Therefore, trajectories and predicted exit times (entrance times into adjacent cell) may widely vary among users as well as the predicted adjacent cell they may eventually enter. That is not to say however that there may not be more than one user leaving a cell on a single route and at or near the same timeframe. Moreover, the processing of users may be more or less intense for any given cell based in part on the complexity of the infrastructure within a given cell. For example, one cell may contain only one thoroughfare leading in and out of the cell, and perhaps one intersecting railway to consider. Another cell may contain many urban routes leading in and out of the cell. Such consideration may be mitigated in part by creating rules that apply to individual cells. One example might be for an urban cell, only phones trackable on major highway trajectories would be considered for service according to some cases of the present invention. In a rural cell there may be only one or two roads to consider therefore all phones in transit could be tracked to one or the other trajectory.

At act 208, if it is determined that there are one or more phones leaving the cell, then at act 209 the service predicts if there will be available bandwidth for those phones in the subsequent cell they are entering. Act 209 is performed individually for each phone leaving the cell and may include pinging the system of the adjacent cell to requesting information about the total bandwidth being used at the time of the ping and any data known at the time including predictive data about phones that may leave the entrance cell within a set time frame. At step 209, the software already has determined the estimated need times for the one or more users leaving the cell and entering the next cell. If the entrance cell in question can predict the numbers of its own users leaving the cell then a predicted availability of a channel may be made. For each user leaving the cell, the prediction determines what channels will be available for the user at the time he or she will enter the adjacent cell.

At act 210, it is determined if there will be any service available or not for each user. If the prediction at act 209 resulted in a negative at act 210, then the software may send a loss of service advisory to the user in question at act 211. The loss of service alert may be an audible message sent to the cell phone under consideration in such a way as the other party or called party may also here the message. The audible alert may be a distinctive sound or a voice synthesized voice message simply advising the user to please terminate the call and try again. In one example, the alert may be visual instead of audible such as a flashing icon appearing on the display of the phone. In still another example, both audible and visual alert may suffice.

If at act 210, it is determined that there will be service available for the user coming into the new cell, the time for transferring the user into the new cell is predicted at step 212. At such time then the channel assignment is executed at act 213. At act 212, the system may additionally reserve some available bandwidth from the adjacent cell through simple apportionment based on the known data, or by requesting the assignment from the tower in the adjacent cell. In a preferred case, the software may make all of the determination and channel reservation and assignments based on its coverage of all of the cells of a particular service area. However in one case, the adjacent cell may be part of another carrier network or service area and it may be running its own version of the SW of the present invention for predicting the needs of its users. In this case, separate instances of software may collaborate using a request/response format where a request for a reserved channel is received and is either granted or denied. In either case in the event of a denial or determination of no bandwidth, the user in question may receive an adequate alert as described further above.

It will be apparent to one with skill in the art that the acts represented in flow chart 200 may, according to varied examples, be modified in number or order without departing from the spirit and scope of the present invention. For example, in one case all phones with tracking turned on are monitored for trajectories regardless of how close they may be to the outer periphery of a cell and the estimated time that any of those phones might actually leave the cell is available to the system even if those phone change trajectory and do not leave the cell.

In one case, cell phone users may elect to be tracked specifically for the purposes of the present invention after downloading and installing a small lightweight application adapted for the purpose and then initiating a location tracking feature, perhaps through the application. In this case, the system would only track those users who have initiated the service through their own applications. An advantage of this example is that the number of users tracked for predictive channel reassignment would be reduced and would not necessarily take into account users who may be in transit but ultimately will not require service according some cases of present invention because ultimately they would not be exiting a cell. Another variance that may occur between in some cases of the present invention is that in act 210, determining whether service is available may be performed from a centralized control point requiring no negotiation in some cases. Alternatively, service availability and bandwidth reservation may be subject to negotiation between 2 or more routers in a distributed in some cases. There are many possibilities.

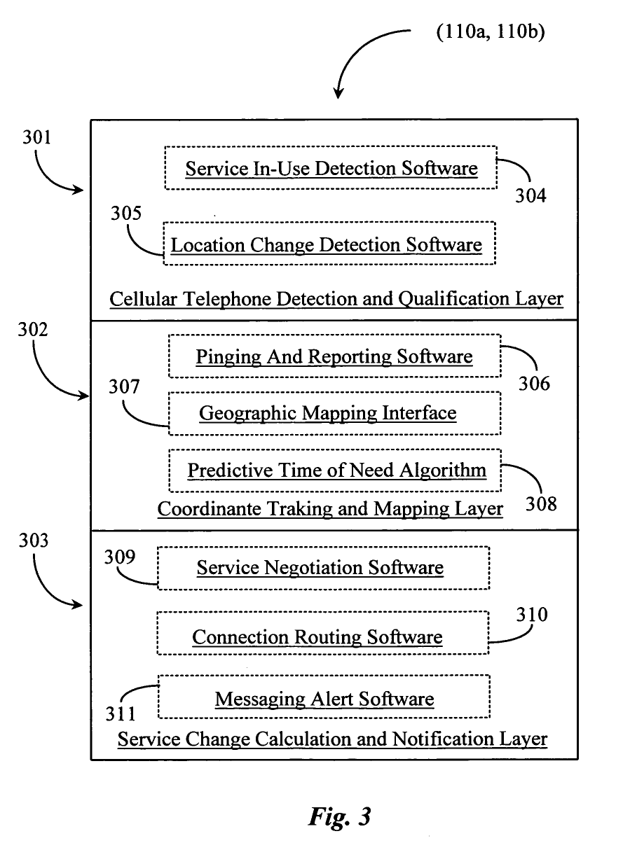

FIG. 3.is a block diagram illustrating basic components of software 110a/110b of FIG. 1 according to an embodiment of the present invention. For purposes of clarity here software 110a or 110b shall be referred to herein simply as software 110. Reference to version a or b of software 110 simply indicates that it may be installed in more than one host as was described with reference to FIG. 1. Likewise, it may be a multipart application distributed to two or more host including the possibility of a lightweight and downloadable client without departing from the spirit and scope of the present invention.

In this example, SW 110 has three basic software layers. These are a telephone detection and qualification layer 301; a coordinate tracking and mapping layer 302; and a service change calculation and notification layer 303. It should be noted herein for discussion purposes that the scope of the present invention is not limited to cellular telephones for successful practice. Methods and apparatus of the invention may be adapted to include other wireless communication devices capable of sending and receiving telephony calls over a wireless network such as hand held computers, personal digital assistants, wireless laptops, and so on. Likewise, the methods and apparatus of the invention may be successfully practiced both in analog networks and in digital networks.

Layer 301 is adapted to detect and qualify a mobile communication device such as a cellular telephone for service according to an embodiment of the present invention. As described further above, a cellular phone might be tracked and qualified for service if certain criteria are satisfactorily met according to rules inherent to the particular implementation of the service, which may vary according to design and overall intent. Generally speaking, a user may not be tracked if his or her phone is not powered on, or is powered on but tracking is disabled. A user whose phone is powered on with tracking enabled may be subject to detection by the system of the present invention.

Layer 301 includes, in this example, a “service-in-use” detection software module 304 provided therein. Module 304 may be adapted to determine and identify a number of users who have their phones turned on and tracking enabled through a lightweight client application installed on their devices. In this case, other users who may have their phones powered on and 911 tracking enabled may not be considered if they have not initiated service through a client. In another case, module 304 may be adapted to identify all users in the cell who have their phones on with tracking enabled whether or not they are in transit.

Layer 301 includes a location change detection software module 305. Module 305 may be adapted in one case to detect the number of users identified by module 304 who are in transit (location changing). Module 305 may determine a transit state of a user by performing a location check at least 2 times in succession for that user and calculating the distance between the two or more samples taken. At this point, it may be too early to predict a consistent trajectory, but the users are known to be in transit or moving away from an original location.

Layer 302 is adapted to further refine transit determination of users. In one case, a pinging and reporting software module 306 is provided and is adapted to ping cell phones or a central location server according to some repetitive pattern to acquire a set of GPS or other type of location coordinates for each phone at each time point the coordinates are requested. Module 306 may establish a trajectory after a sufficient number of “location requests” are performed for a particular phone. It is noted herein that a directional trajectory may be established without any specific “street or road mapping” performed as long as the four main directions, North, South, East, and West are known.

It is important to note herein that identifying and tracking a user is not specifically dependant on whether the user is engaged in any conversations using the phone. However, in one example the service of the present invention requires that the user be engaged in a conversation to be considered for channel-reassignment because if the user is not conversing no channel need be reserved for that user in transit between cells.

Layer 302 includes a geographic mapping interface 307. Interface 307 provides system access to detailed mapping information covering each cell in a service coverage area. In general, mapping information may include highways, major roads, thoroughfares, streets, and even bicycle paths or off road trails if available. The reason for mapping information may be to provide service only for certain highways or thoroughfares such that tracked users in transit and engaged in a call may not be serviced if they are traveling on a path or trajectory not considered a serviceable thoroughfare.

In some cases, road and thoroughfare mapping is not specifically required as long as the cell boundaries are known and trajectories within those cell limits can be accurately established based on any geographic descriptions such as a land mark, longitude and latitude, and so on. In this case, it would not matter what path a user is transiting as long as a trajectory may be established and that the average time it would take the user to leave the cell on that trajectory can be calculated. Module 307 may include selective information generic to each cell and may be highly detailed or not depending on the intent of the service of the present invention.

Layer 302 includes a predictive “time of need” algorithm 308 provided therein and adapted to predict times that users exiting a cell to an adjacent cell will need a channel reassignment while engaged in a conversation. Algorithm 308 uses information provided by modules 306 and optionally 308 for all users that fit the criteria of the service. The algorithm fires and calculates a need time for each user that is exiting the cell at any given time. In one case, the algorithm only fires for users who have entered an established buffer region in the cell and therefore are considered highly likely to enter an adjacent cell at the predicted point in time for that user. The channel reassignment is only necessary if a user is leaving the cell and is engaged in a conversation while in transit across the cell border. However, if a user terminates a conversation just before leaving the cell, he or she may still be considered for reassignment until the predicted time approaches in case another call is initiated within the time span between the termination of the call and the predicted time of need providing that the time span is sufficient before losing coverage of the previous cell.

Layer 303 is adapted to determine service availability in an adjacent cell and to determine or negotiate for available bandwidth to transfer a user's call in progress call to. A service negotiation is provided within layer 303 in one case. Module 309 may be adapted to pre-negotiate for and reserve a channel for any user that is expected to enter a cell and who has a call in progress necessitating a cell handoff. Module 309 may provide the identification of the user's device and the expected time that the user will require a new channel to maintain the call in progress in the adjacent cell. Module 309 may also be adapted to determine if there might be channels available at the time the user will enter the adjacent cell. In this regard, the adjacent cell may also have users leaving the cell at predictive times and can therefore provide overall usage statistics and expected usage statistics taking into account expected departures from the adjacent cell into other cells. Therefore, if at first request, there appears to be no channels available, there may be one or two that may be expected to be available according to the predictive routine operating in the adjacent cell.

In one case, there is no negotiation between cells but rather a determination is made from a central location responsible for the entire cell coverage area including all of the cells. In this case, the data from all of the cells is immediately available and allocating a channel for a user transiting cell borders while engaged in a conversation is a matter of predicting availability and reserving bandwidth.

Layer 303 includes a connection routing software module 310. Module 310 is adapted in this case to execute channel reassignments to reserved channels for users crossing cell borders at the predicted time of need for those users. Module 310 may be an existing routing application in place for performing normal channel reassignments. The only modification to the routing routine may be that it is enhanced according to the present invention to route a reserved channel reassignment whether or not the channel was actually available at the time of the routing request.

Layer 303 includes a messaging alert software module 311, which may be adapted to send some visual or audible alert to a user crossing a cell border in the event that no bandwidth was reserveable within the time period that a reassignment was necessary for the user to continue his or her conversation. The alert may be a text message, an audible beep or sound, a flashing icon on the display, or a synthesized audio interruption over the current call channel. The alert may inform the user that it does not appear he or she will be able to continue their conversation if the user proceeds on the current trajectory. The user may after receiving the alert, pull over to finish the conversation, take a detour in a direction other than the current trajectory to finish the call, or simply finish the call quickly or reschedule the call at a latter time.

It will be apparent to one with skill in the art that the methods and apparatus of the present invention may be practiced in analog or digital cellular network environments without departing from the spirit and scope of the present invention. It will also be apparent that the methods of the invention may be implemented with all or some of the features described herein without departing from the spirit and scope of the present invention. Likewise, the methods of the present invention may be successfully practiced with or without detailed maps of roadways or streets and with or without special cell buffer regions described further above.

In some cases, the resulting reduced dropped call rates may be sold as a premium service. In yet other cases, non-premium customers may be dropped in order to provide premium customers with better service. In some cases, a rating, based on for example including but not limited to total monthly billing, late payments etc. may be used to determine which customers to drop.

In light of the many possible examples and application of the broader invention, the methods and apparatus described herein should be afforded the broadest possible consideration. The spirit and scope of the present invention should be limited only by the following claims.

What is claimed is:

1. A system for predicting a requirement for a channel reassignment for a mobile communications device engaged in a call while traversing from one to another cell of a wireless communications region comprising:
a first node running a first software routine for qualifying the mobile communications device for tracking and for tracking the mobile communications device on a trajectory;
a second software routine running on the first node or another node connected thereto for predicting a time of need for the channel reassignment to the mobile communications device;
a third software routine running on the first node or on another node connected thereto for predicting bandwidth availability to the mobile communications device at the time of need, the prediction made at a point before the predicted time of need of the channel reassignment; and
a fourth software routine running on the first node or another node connected thereto for causing execution of the channel reassignment substantially near the predicted time of need of the channel reassignment and for causing notification to the mobile communications device in the event of insufficient bandwidth at a point before the predicted time of need for the channel reassignment.

2. The system of claim 1, wherein the mobile communication device is one of a cellular telephone, a laptop, or a personal digital assistant.

3. The system of claim 1, wherein the wireless communication is analog.

4. The system of claim 1, wherein the wireless communication is digital.

5. The system of claim 1, wherein the first node is a server node maintained by a wireless carrier responsible for the wireless communications region.

6. The system of claim 1, wherein the first node is a router.

7. The system of claim 1, wherein qualification includes determination that the device is in transit in a manner that creates a trajectory.

8. The system of claim 1, wherein the trajectory is mapped to one of a thoroughfare, a highway, a street, or a transit mute.

9. The system of claim 1, wherein tracking is achieved using a global positioning satellite.

10. The system of claim 1, wherein tracking is achieved using triangulation.

12. The system of claim 1, wherein the prediction of time of need is based on trajectory of the mobile communications device and the average speed of the device.

13. The system of claim 12, wherein the predicted time is substantially near the actual time the mobile communications device transverses the cell border.

14. The system of claim 1, wherein the notification of insufficient bandwidth is one of a text message, an audible beep, a flashing icon, or a synthesized voice message breaking into the conversation.

15. The system of claim 1, further including a client application distributed to the mobile communications device, the client application adapted to initiate tracking mapping and service negotiations performed by the system software routines.

16. A software application for predicting and then routing channel reassignments to mobile communications devices engaged in communication sessions while traversing a cell border within a cellular service area comprising;
a first portion thereof for detecting trackable devices and for tracking qualified devices while in transit along a trajectory;
a second portion thereof for mapping the trajectories to known routes and for predicting times at which those devices will need channel reassignments; and
a third portion thereof for predicting bandwidth availability for the predicted channel reassignments and for reserving bandwidth for those reassignments.

17. The software application of claim 16, wherein the mobile communications devices are one or a mix of cellular telephones, laptop computers, or personal digital assistants.

18. The software application of claim 16, further including a distributed client downloadable to the mobile communications devices and configurable to initiate service.

19. The software application of claim 16, further including a portion thereof for executing channel reassignments and for causing notification to mobile communications devices in the event no bandwidth could be reserved.

20. The software application of claim 19, wherein notification is one of a text message, a flashing icon, an audible beep, or a synthesized voice message inserted into the communication session.

21. A method for predicting a time of need for a channel reassignment for a mobile communications device traversing a border between cells in a wireless communications service area including acts for:
(a) detecting a mobile communications device in session;
(b) determining the device is in transit on a trajectory; and
(c) predicting when the device on the trajectory will cross a cell border into an adjacent cell.

22. The method of claim 21 wherein in act (a), the mobile communications device is one of a cell phone, a laptop computer, or a personal digital assistant

23. The method of claim 21 wherein in act (b), the determination is based on at least 2 location requests based on one of global satellite positioning or triangulation.

24. The method of claim 21 wherein in act (c), the prediction is performed via algorithm considering as variables direction of trajectory; average speed of the mobile communications device along the trajectory; and proximity of the mobile communications device on the trajectory in relation to the cell border at the time of prediction.
